(19) United States
(12) Patent Application Publication
(10) Pub. No.: US 2006/0265388 A1
(43) Pub. Date: Nov. 23, 2006

(54) Information retrieval system and method for distinguishing misrecognized queries and unavailable documents

(76) Inventor: Joseph K. Woelfel, Watertown, MA (US)

Correspondence Address: Patent Department;Mitsubishi Electric Research Laboratories, Inc., 201 Broadway, Cambridge, MA, 02139, US

(21) Appl. No.: 11/134,690

(22) Filed: May 20, 2005

(51) Int. Cl. G06F 17/30

(52) U.S. Cl. 707/10

(57) ABSTRACT

A system and method disambiguates between an incorrectly recognized spoken query and a correctly recognized spoken query for which there are no currently available documents in a database. The method generates a list of unavailable categories of documents. The method also generates surrogate documents that include query terms similar to the categories of unavailable documents. Each surrogate documents also includes a description that indicates why the document is not available. The surrogate documents are included in the database along with the available documents. Spoken queries are matched against all documents in the database including the surrogate documents. If a surrogate document is retrieved, then the user is presented with the description that describes why that category of documents is not available.

### FIELD OF THE INVENTION

The present invention relates generally to indexing and retrieving documents from dynamic databases, and more particularly to speech-based information retrieval from databases that may not contain expected documents.

### BACKGROUND OF THE INVENTION

Most text-based information retrieval systems rely on the use of a keyboard and a display device. The keyboard is used to type in keywords. Typically, the keywords are displayed prominently on the display device along with a retrieved list of ranked documents. It should be understood that the documents can be in any form, such as text, image, audio, video files, and so forth.

The keyboard is a reliable device for entering text, and the display device can confirm what was typed. Further, the entered text can be checked for spelling and grammatical errors to provide additional assurance. As such, the text-based retrieval system can assume that the keywords in the query are correct.

However, in some circumstances, a keyboard and a display screen are impractical, for example, when driving, operating machinery, or doing any activity that requires considerable use of the hands and eyes. In such situations, retrieval by spoken queries is preferred.

Speech-based information retrieval differs from text-based retrieval in that the spoken query, after speech recognition, is not known with certainty. For numerous well-known reasons, e.g., noise, speech variability, dialect, etc., speech recognitions will never be completely accurate. In addition, a display device may not be available to confirm that the spoken words in the query were recognized correctly. Even if a display device is available, the converted query words may not be viewable. This is because the speech recognition may use a word lattice, or some other intermediate phonetic representation for retrieval, rather than attempting to recognize the entire spoken query as text.

Because spoken queries are not recognized with certainty, and cannot be confirmed, a user cannot distinguish between a misrecognized query and a database that does not include the desired document. This is particularly problematic in dynamic databases where documents change over time, such as documents available through the Internet.

One such database is a point of interest database. For example, the user desires to locate a particular type of business, such as a Japanese restaurant. If the spoken query yields no correct results, then this may be due to an incorrectly recognized spoken query, or due to the fact that there is no Japanese restaurant.

### SUMMARY OF THE INVENTION

The invention provides a system and method for disambiguating between an incorrectly recognized spoken query, and a correctly recognized spoken query for which there are no currently available documents in a database.

The method generates a list of unavailable categories of documents. The method also generates surrogate documents that include query terms similar to the categories of unavailable documents. Each surrogate documents also includes a description that indicates why the document is not available. The surrogate documents are included in the database along with the available documents.

Then, spoken queries are matched against all documents in the database including the surrogate documents. If a surrogate document is retrieved, then the user is presented with the description that describes why that category of documents is not available.

### BRIEF DESCRIPTION OF THE DRAWINGS

FIG. 1 is a block diagram of a spoken query information retrieval system according to one embodiment of the invention.

### DETAILED DESCRIPTION OF THE PREFERRED EMBODIMENT

System Structure

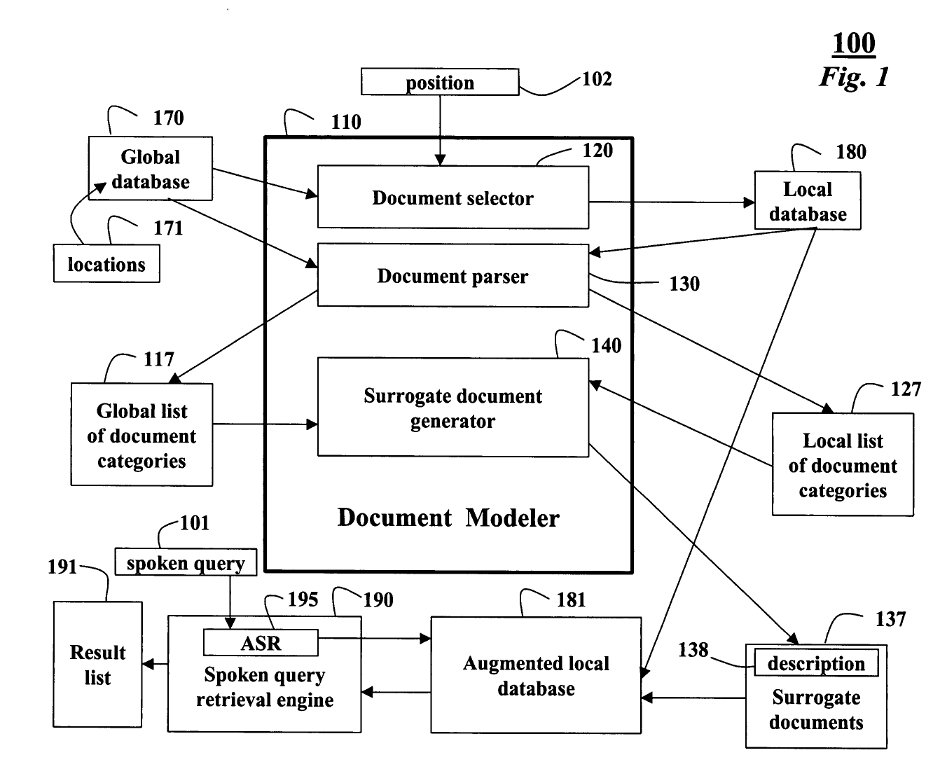

As shown in FIG. 1, a spoken query information retrieval system 100 includes a document modeler 110. The document modeler 110 includes a document selector 120, a document parser 130, and a surrogate document generator 140. The document modeler 110 has access to a global database 170, a local database 180, a global list of document categories 117, a local list of document categories 127, and surrogate documents 137. A spoken query retrieval engine 190 has access to an augmented local database 181, which can also be accessed by the local database 180. The retrieval engine 190 includes an automatic speech recognizer (ASR) 195.

For an example application, the documents include information about the geographical locations 171 of points of interest. A user of the system is at a known position. The user desires to locate a nearby point of interest. Therefore, the user supplies a spoken query 101 and a position 102.

The invention can also be used with other types of information that is not necessarily location and point-of-interest oriented.

System Operation

The document selector 120 extracts documents from the global database 170 and inserts the extracted documents in the local database 180 according to a predetermined selection criterion. For example, the document selector 120 determines a distance from each location 171 in each point of interest in the documents in the global database 170 to the position 102 of the user. For this example selection criterion, documents are selected if the distance is less than a predetermined distance threshold. It should be noted that other selection criteria can also be used.

The document parser 130 determines categories for all documents in the global and local databases, and constructs the global list of document categories 117 and the local list of document categories 127, respectively. For example, the categories are types of restaurants.

The surrogate document generator 140 produces a surrogate document 137 for each category represented in the global list of document categories 117 that is not included in the local list of document categories 127. Each surrogate document includes a description 138 of why the document is not available. For example, the desired type of restaurant is too far from the user. The resulting surrogate documents 137 are then combined with the local database 180 to produce the augmented local database 181.

The spoken query 101 is recognized and converted to a search query by the ASR 195. The search query can be text, a word lattice, or a phonetic representation. The search term is used to search the augmented database 181 to produce a result list 191 of documents matching the spoken query. The documents in the result list can be ranked for relevance with respect to the spoken query by the retrieval engine 190.

If a surrogate document appears in the list, a description of why the document is not available is also presented. In this way, it is clear to the user that the speech recognizer correctly recognized the spoken query 101.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

I claim:

1. A method for retrieving documents from a database, using a spoken query, comprising:
selecting documents from a global database according to a predetermined selection criterion;
inserting the selected documents in a local database;
parsing each document in the global database to produce a global list of document categories;
parsing each document in the local database to produce a local list of document categories;
generating a surrogate document for each category represented in the global list of document categories that is not included in the local list of document categories, the surrogate document including a description of why the document is not available in the local list of document categories;
converting a spoken query to a search query; and
searching the local database and the surrogate documents to produce a result list.

2. The method of claim 1, further comprising:
combining the local database and the surrogate documents in an augmented database; and
searching the augmented database to produce a result list.

3. The method of claim 1, in which each document describes a point of interest, and each document includes a location of the point selection, and the search criteria is a distance between each location and a known position.

4. The method of claim 3, in which the position is associated with a user.

5. The method of claim 3, in which the distances are compared to a predetermined distance threshold.

6. The method of claim 1, in which the search query is text.

7. The method of claim 1, in which the search query is a word lattice.

8. The method of claim 1, in which the search is a phonetic representation.

9. The method of claim 1, further comprising:
ranking documents included in the result list according to relevance with respect to the spoken query.

10. A system for retrieving documents from a database, using a spoken query, comprising:
means for selecting documents from a global database according to a predetermined selection criterion;
a local database including the selected documents;
means for parsing each document in the global database to produce a global list of document categories;
means for parsing the each document in the local database to produce a local list of document categories;
means for generating a surrogate document for each category represented in the global list of document categories that is not included in the local list of document categories, the surrogate document including a description of why the document is not available in the local list of document categories;
means for converting a spoken query to a search query; and
means for searching the local database and the surrogate documents to produce a result list.
